(19) United States
(12) Patent Application Publication
(10) Pub. No.: US 2010/0171616 A1
(43) Pub. Date: Jul. 8, 2010

(54) Providing a traveler with offers particularly suited to that individual

(76) Inventor: Cart J. Walliser, Mundelein, IL (US)

Correspondence Address: EUGENE F. FRIEDMAN;FRIEDMAN & FRIEDMAN, LTD., Printers Square-- Suite 710, 780 South Federal Street, CHICAGO, IL, 60605, US

(21) Appl. No.: 12/319,464

(22) Filed: Jan. 6, 2009

(51) Int. Cl. G08B 13/22; G06Q 30/00; G06Q 50/00

(52) U.S. Cl. 340/572.1; 705/10; 705/14.1; 705/14.36

(57) ABSTRACT

The use of RFID (radio-frequency identification) chips in luggage tags to provide travelers with coupons and information related to their respective destinations. The luggage (or “bag”) tag will include an embedded RFID chip. When the traveler checks his or her suitcase or other package, the bag-tag printer will place a visual representation of the traveler's destination on the tag. However, the printer will also “write” the traveler's identification and either a validate code or the destination on the embedded chip. The traveler, arriving at his or her destination and retrieving the checked item, can then place the bag tag near an RFID scanner which can read the information about the traveler's destination and possibly the traveler him-or herself. The scanner can then print out coupons pertinent to the traveler, the destination of the luggage, or the location of the scanner itself. After reading the information from the RFID chip, the scanner may then write to the chip that the coupons and the like have been issued to “cancel” the chip for the purpose of preventing repetitive uses of the tag. The same concepts allow for advertising and promotions at other locations and for notices and information at not related to advertising.

### CROSS REFERENCE TO RELATED APPLICATIONS

The present application claims the priority of the PCT application PCT/US2007/016518 filed on Jul. 23, 2007, which, in turn, claimed the priority of the filing of the U.S. provisional patent application 60/833,2295 filed on Jul. 25, 2006, of which the present application also claims the priority.

### BACKGROUND

Radio-frequency identification (“RFID”) chips are finding use throughout industry. Essentially, an RFID chip serves to provide information about a package's or parcel's actual or intended location. Attached to the package or parcel, it passes through a reading device, or scanner, as it moves into, out of, or around within a building or a package handling system. The scanner receives information encoded on the chip which it may then store or pass onto a data processing center such as a computer. The information accumulated from such chips then allows more accurate control of inventory and theft. The direct and immediate knowledge of inventory provided by RFID chips then lead to specific ordering and “just-in-time” delivery of either component parts for a manufacturer or final product for merchandisers.

For a package in transit, an attached RFID chip may serve to facilitate the package's arrival at its correct destination. The chip may do this either by controlling automated sorting equipment or simply informing a human worker (through the use of a screen or the like) of the package's intended arrival point. The chip may also allow for an alarm if a package has ended up in the wrong location prior to further travel.

The above description shows the particular utility that RFID chips may have for the luggage of passengers on commercial airlines or other modes of travel. The airlines make every effort to make sure that checked luggage arrives at the correct location on the right flight. In fact, the airlines do an excellent job of carrying out this responsibility. The very rare instance of failure, however, produces enormous passenger ill will and expense that the airlines devoutly seek to avoid.

To reduce even further the instances of misdirected or delayed baggage, the airlines are considering the embedding of RFID chips in the luggage (or “bag”) tags that they attach to the passengers' suitcases and other checked or shipped packages. The hope is that the use of the chips will reduce even further the small number of mistakes that occasionally beset such operations. Further, the chips may allow for more automated handling and a possible reduction in costs. On the other hand, the inclusion of the chips themselves in the bag tags will naturally increase the cost of the tags themselves. Obviously, this expenditure provides a significant concern to airlines which are seeking to reduce their costs in order to provide even more economical travel to the public.

Publications discussing RFID devices include U.S. Pat. No. 5,640,002 issued on Jun. 17, 1997, to J. P. Ruppert et al; U.S. Pat. No. 6,002,344 issued on Dec. 14, 1999, to W. R. Randy et al; U.S. Pat. No. 6,400,272, issued on Jun. 4, 2002, to H. N. Holtzman et al; U.S. Pat. No. 6,476,718 issued on Nov. 5, 2002, to C. L. M. Cartwright et al; U.S. Pat. No. 6,657,543 issued on Dec. 2, 2003, to K. K.-T. Chung; U.S. Pat. No. 6,717,507 issued on Apr. 6, 2004, to O. T. Bayley et al; U.S. Pat. No. 6,967,579 issued on Nov. 22, 2005, to P. Elizondo; U.S. Pat. No. 6,973,385 issued on Dec. 6, 2005, to H. B. Ulrich; and U.S. Pat. No. 6,978,118 issued on Dec. 20, 2005, to P. Vesikivi et al. Additional discussions of RFID devices appear in U.S. patent publications US 2003/0006878 A1 published on Jan. 9, 2003, of U.S. patent application Ser. No. 10/171,015 of K. K.-T. Chung filed on Jun. 13, 2002; US 2003/0128100 A1 published on Jul. 10, 2003, of U.S. patent application Ser. No. 10/303,668 of D. P. Burkhardt et al. filed on Nov. 25, 2002; US 2004/0260646 A1 published on Dec. 23, 2004, of U.S. patent application Ser. No. 10/810,473 of M. J. Berardi et al. filed on Aug. 30, 2004; US 2005/0150952 A1 published on Jul. 14, 2005, of U.S. patent application Ser. No. 11/074,570 of K. K.-T. Chung filed on Mar. 8, 2005; US 2005/0168340 A1 published on Aug. 4, 2005, of U.S. patent application Ser. No. 11/059,793 of W. W. Mosher, Jr., et al., filed Feb. 16, 2005; and US 2005/0253717 A1 published on Nov. 17, 2005, of U.S. patent application Ser. No. 10/866,285 of A. G. Howarth et al., filed on Jun. 9, 2004. All of these are incorporated by reference here.

### SUMMARY

RFID chips have the capability of doing more than merely tracking the presence or location of bags, packages, or even persons to which they are attached and, perhaps, guiding them on to other locations. They may also provide the owner of the bags or other packages or the wearer or holder of the chips with information, offers, and coupons specifically tailored to that individual or his or her location. A method of providing a traveler or other consumer with offers, notices, and/or coupons particularly suited to that traveler or other consumer includes first providing that traveler or other consumer with a physical object containing information related to the traveler or other consumer. A device is then provided that is capable of reading the information from the object at a location accessible to the traveler or other consumer. The information is then read with the device. Finally, after the device has read the information, the offers, notices, and/or coupons are provided to the traveler or other consumer from the device.

Typically, the physical object may take the form of a label, ticket, worn item, or bag, or luggage, tag with an embedded or attached RFID chip. Alternately, the traveler's ticket or boarding pass may include such a chip. As a further possibility, the traveler or other individual may wear the chip in a wristband or the like. In this instance, the method could find particular use in hospitals, athletic events, and similar situations where individuals do not typically carry external items with them.

The device that reads the chip and provides the information or coupons may also serve additional purposes. First, it may actually collect information about the traveler or other consumer for the use in security or marketing situations. The device may also write to the chip that the desired activity has occurred. This can serve to prevent repetitive uses of the chip to obtain multiple offers, coupons, and the like. In a sense, the reading device “cancels” the chip.

In a broader sense, the same concepts may find use in a method of advertising. In this instance, the method involves entering into an agreement with an advertiser entity to provide coupons, offers, and/or notices to selected individuals. The advertiser entity may include an advertising agency, a company providing goods or services to the public or selected portions of it, or others. To provide for “targeted advertising,” the method then proceeds to deciding what categories of selected individuals will receive particular coupons, offers, and/or other information.

A physical object then receives encoding with information particularly related to the selected individuals. Alternately, the encoding may simply “validate” the physical object. These individuals are then provided with this physical object. A device capable of reading the information from the object is providing at a location accessible to the selected individuals.

The device then reads the information on the physical object. After the device has read the information, the categories of selected individuals are provided with the particular coupons, offers, and/or notices from the device.

Alternately and more generally, the method may provide offers, notices, and/or coupons to selected individuals. It commences with deciding what categories of selected individuals will receive particular coupons, offers, and/or notices. Some sort of physical object is encoded with information particularly related to these selected individuals who are provided with the physical object itself or with a simple validate code.

A device is then provided that has the capability of reading the information from the physical object at a location accessible to the selected individuals. The device then reads the information on the physical object. Afterwards, the particular coupons, offers, and/or notices are provided from the device to the categories of selected individuals or to all persons presenting a physical object with a valid code.

### BRIEF DESCRIPTION OF THE FIGURES

FIGS. 1A to 1J illustrate the steps for creating and using an RFID chip embedded in a luggage tag to provide a traveler or other consumer with coupons and other information and promotional items.

FIG. 2 shows a scheme for producing materials to travelers or other consumers from an RFID chip in which the entity actually interfacing with these individuals encodes the chip with the information as to the specific items provided to the individuals or with a validate code.

FIG. 3 gives a system similar to that of FIG. 2 but in which the maker or supplier of the RFID-chip-embedded items actually encodes the chips with indicia of the advertising or other information that the traveler or other consumer will receive or with a validate code.

FIG. 4 shows a scheme for providing information, coupons, or other offers to consumers or travelers using reading devices (“smart kiosks”) programmed with the specific information that these individuals will receive.

FIG. 5 provides a scheme similar to that of FIG. 4 except the RFID chips (“smart chips”) receive the encoding as to the particular items that the individual will receive.

FIG. 6 displays a boarding pass containing an RFID chip that may serve to initiate the production of coupons, offers, or other information for travelers or other individuals.

FIG. 7 illustrates individuals wearing wristbands with embedded RFID chips that will serve to provide those persons with printed information, coupons, or other materials.

FIG. 7A provides an enlarged view of the encircled portion 7A of FIG. 7 showing the wristband with an embedded RFID chip.

FIG. 8 shows the dispensing of individually selected offers, notices, or coupons at a general store rather than at an airport.

FIG. 9 illustrates a patient at a hospital receiving information directed to her condition and an alarm sounding if the patient has not obtained the desired or even necessary directions.

FIGS. 10A and 10B show a tag having an optical code that remains valid and that has been cancelled, respectively.

FIG. 11 presents a boarding pass that has a magnetic strip on it and which can find use to generate the advertisements, promotions, and notices provided to a traveler or other individual.

### DETAILED DESCRIPTION

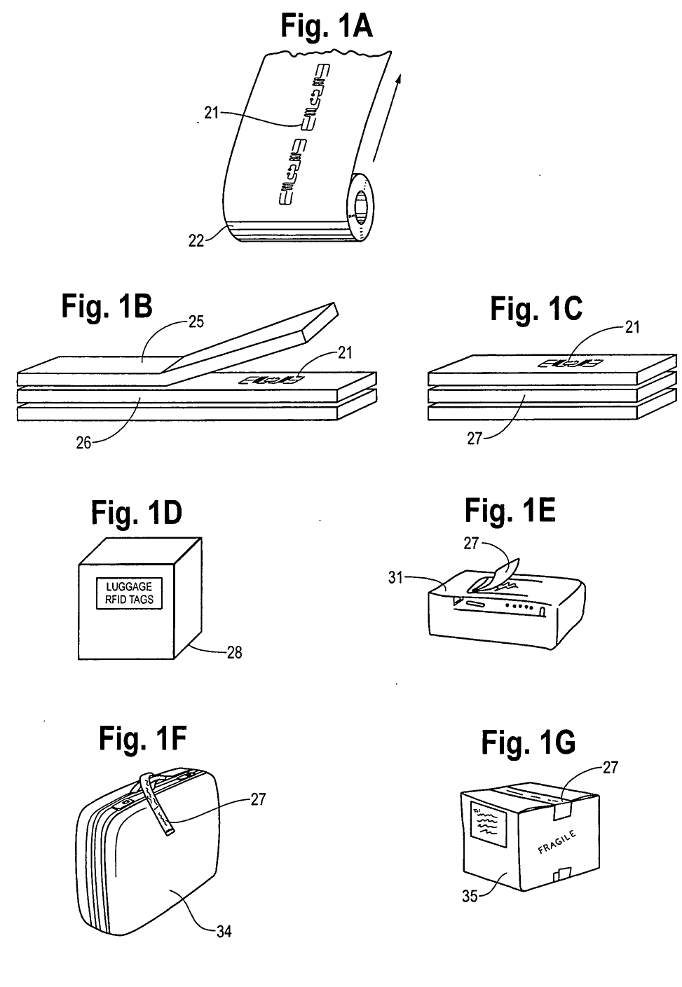

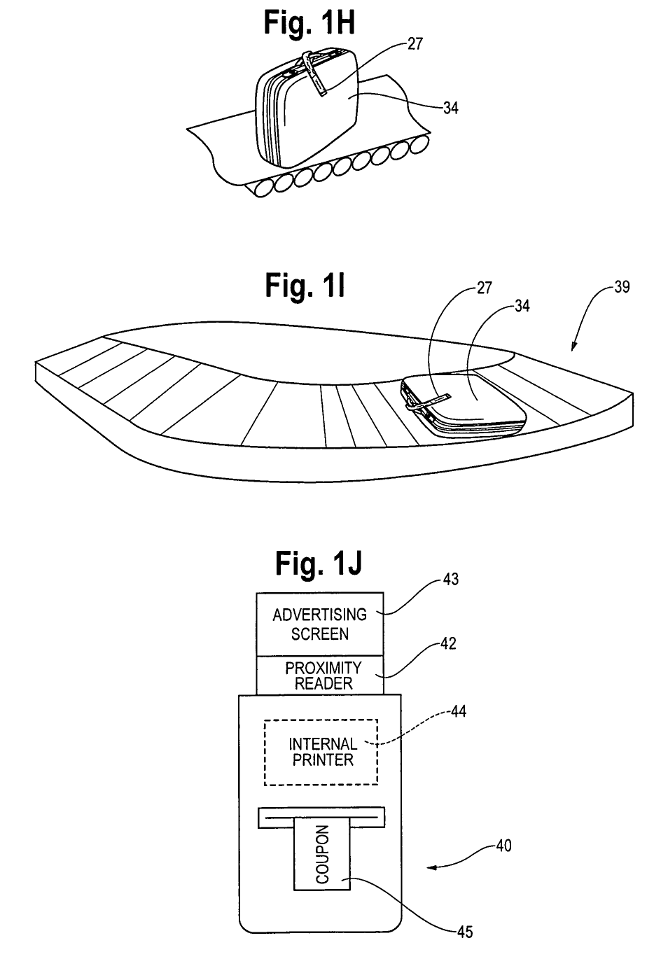

In FIG. 1A, the RFID chips 21 arrive on the roll 22. The bag-tag manufacturer then places them between the layers 25 and 26 when making the rolls of tags as seen in FIG. 1B. Upon cutting the roll of prepared but blank tags as in FIG. 1C, the individual RFID chip 21 forms part of the bag tag 27.

After completing the fabrication of the tags, the manufacturer may pack them in the boxes 28 as seen in FIG. 1D and supply them to the airlines, for example. The airline then places the tags in the printer 31 which individualizes the tags 27 for the particular traveler. The tags 27 may include the name of the traveler and his or her destination. At the same time, the printer 31 may write information to the RFID chips 21 or simply validate them. Additionally, the chips 21 may include information placed on them during their manufacture.

The chips 21 with the information, whether placed on them by the printer 31 or during manufacture, then attach to the suitcases 34 or boxes or other containers 35 in the usual fashion as indicated in FIGS. 1F and 1G, respectively. The airline attendant may place the tags 27 on the suitcase 35 or the container 35. Very often now to save time, the traveler has the option of checking in his or her own baggage and accordingly places the labels 27 on them himself or herself.

The bag 34 with its attached tag 27 then typically travels along the conveyor indicated generally at 38 for sorting and placement on the appropriate aircraft as shown in FIG. 1H. After arrival at its destination, the bag 34 with its label 27 then receives a ride on the carousel indicated generally at 39 in FIG. 1H where it awaits retrieval by its owner. After reobtaining his or her suitcase 34, the passenger may then take the bag tag 27 to the kiosk indicated generally at 40 in FIG. 1J. There, the proximity reader portion 42 of the kiosk 40 obtains the information contained in the RFID chip in the bag tag 27. At this point, the advertising screen 43 may display information relevant to the particular traveler or to the kiosk's location. Further, the kiosk's printer 44 provides the coupons that may have general effect for a worldwide business or is specifically tailored to the traveler or to the kiosk's location itself.

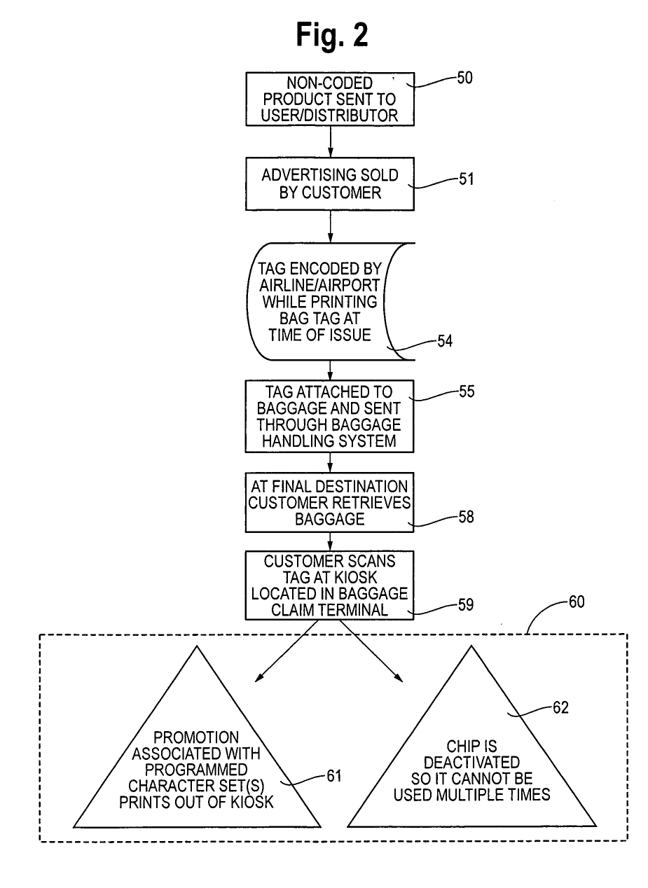

FIG. 2 describes in more detail the steps involved in one scenario of the use of encoded RFID chips on bag tags for advertising purposes. There, the manufacturer or distributor of bag tags sends such labels without advertising encoding to the user airline or the like or to an intermediate distributor, as seen in the box 50. The purchasers of the bag tags may sell advertising for placement on the unencoded bag tags as the box 51 illustrates. As the airline attendant or other individual (including the traveler himself or herself) prints the tag at the time of its issuance, it is encoded with the information required to provide the tailored materials to the particular individual as illustrated by the box 54. Or, it may simply receive a validating code.

The bag tag is then attached to the luggage or other package and sent through the usual baggage handling system at the airport set forth in the box 55. At his or her destination and as seen in the box 58, the customer retrieves the baggage with the encoded and embedded RFID chips or otherwise.

After obtaining his or her bag, the customer, as diagrammed in the box 59, scans the tag with the encoded RFID chip or other device at the kiosk illustrated diagrammatically as the box 60 composed of dashed lines. The kiosk 60 may then undertake two functions. First it may provide promotions particularly suited for the particular encoding on the traveler's bag tag as shown in the triangle 61. It may also print out other promotional or informational items that may have particular suitability for the kiosk's location or just general advertisements for businesses that appear to have relevance at any city, such as McDonald's restaurants.

At the same time as providing promotions, the kiosk 60 may also “cancel” the bag tag as suggested by the triangle 62. This would involve, for example, further encoding an RFID chip that it has been read. Other types of encoding may receive different cancellations, as discussed below. The encoding process has the purpose of preventing the repeated use of a bag tag to obtain multiple copies of the provided coupons, notices, or other promotional items.

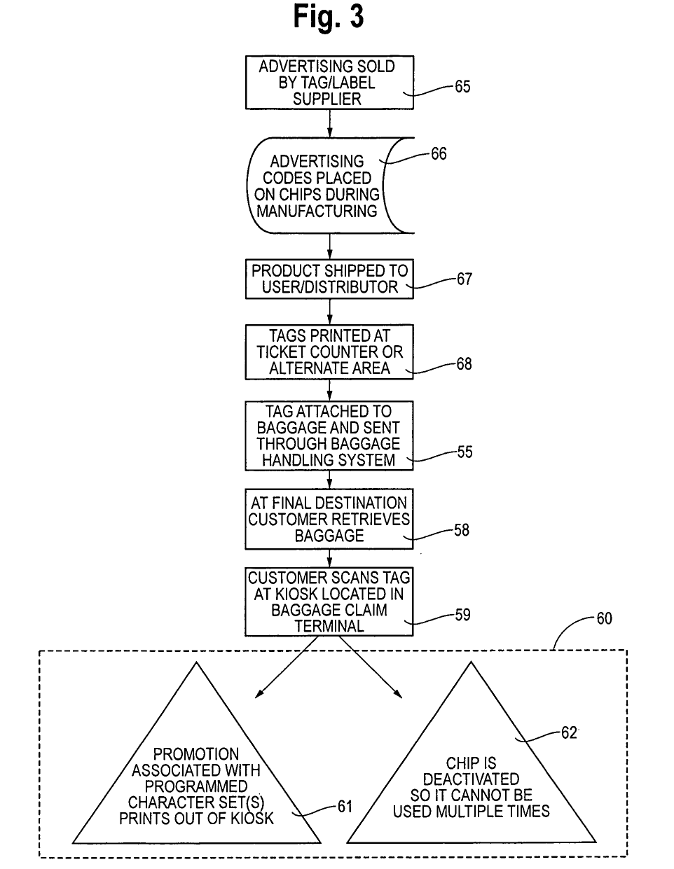

FIG. 3 shows a slightly different scenario for advertising using encoded bag tags. There, as stated in the box 65, the supplier of the bag tags undertakes the effort of selling the advertising that the traveler will receive at his or her destination. This alleviates the task of such commercialization efforts from the multiple responsibilities of the airlines. Yet, the airlines will certainly benefit through a reduction in the costs of the bag tags themselves. The sale of the advertising to companies may be undertaken directly by the tag manufacturer itself or an entity devoted to this task.

In any event, the advertising codes find their way onto the chips as indicated in the enclosure 66. The bag tags with the RFID chip, already encoded with the particular advertising possibilities, then travel to the user or the distributor such as the airline as indicated in the box 67. The tags, after being placed at the ticket counters or check-in stations, are then printed with the usual information such as the traveler's name and destination as the box 68 shows. Although not necessary in this specific process, the RFID chips, although already carrying certain advertising or validate codes, may actually receive further coding.

At this point, the procedure in FIG. 3 follows exactly the same steps as in FIG. 2 and thus the items 55 and 58 to 62 bear the same numbers as in the prior figure. Thus, the tag attaches to the luggage or package and travels through the baggage handling system in the box 55; the traveler retrieves the bag in the box 58 and scans the tag at the local kiosk as seen in the box 59. The promotions then print out at the triangle 61 and the chip deactivated at the triangle 62.

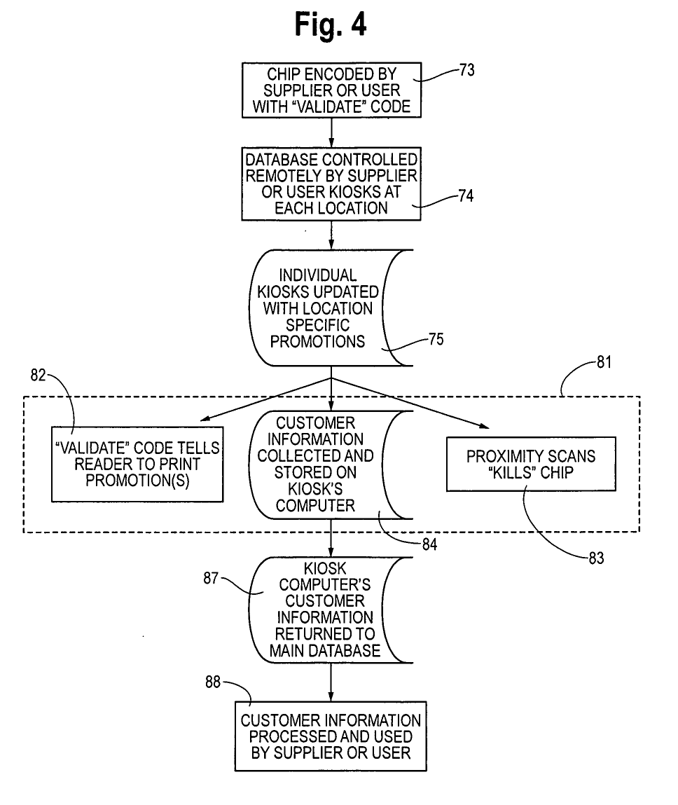

FIG. 4 shows the method of providing advertisements or other information where the kiosk at the destination constitutes the repository of the criteria for matching the traveler to the materials he or she should receive. There, the RFID chip on the bag tag receives a “validate” code placed there by the tag supplier or the user airline, as seen in the box 73. This simply informs the kiosk that it should appropriately respond to the tag (carrying the chip) when placed before it for scanning.

The kiosks, however, receive their specific directions and database for tags presented to them at the box 74. This task is undertaken and controlled at sites remote from the kiosks themselves. Essentially, the information and promotions provided by a specific kiosk will be the same for all validated tags presented for scanning at that location. Thus, as seen in the box 75, the individual kiosks are updated from time to time with promotions for each specific location. Stated in other words, the database developed and controlled at the box 74 finds use in updating the individual kiosks at the box 75 to allow each kiosk to provide its specific promotions to all validated tags presented to it.

When the traveler or other individual presents the bag tag to the kiosk scanner, three separate actions take place, as indicated in the dashed box 81. (All of this is in addition to the display of visual information or commercial messages on the screen 43 in FIG. 11.) First, the “validate” code placed on the RFID chip causes the kiosk to print the coupons, promotions or other desired information as seen in the box 82. At about this time, the kiosk writes to and cancels the RFID chip at the box 83 so that the traveler may not use it multiple times.

Finally, the kiosk may look at the information placed on the RFID chip that relates specifically to the particular traveler presenting his or her bag tag. The chip may receive this information when the bag tag is validated and printed for that individual. The kiosk then collects and stores this particularized information on its computer at the box 84. This information then travels to the supplier's or airline's main database as in the box 87. From there, after processing and perhaps categorizing, it may find use, at the box 88, to develop further information and advertising campaigns. The scenario illustrated in FIG. 4 may be referred to as the “smart kiosk” situation. This simply refers to the fact that the kiosk scans relatively undifferentiated RFID chips on bag tags and makes the determination as to which coupons, items of information, and promotions that the traveler will receive.

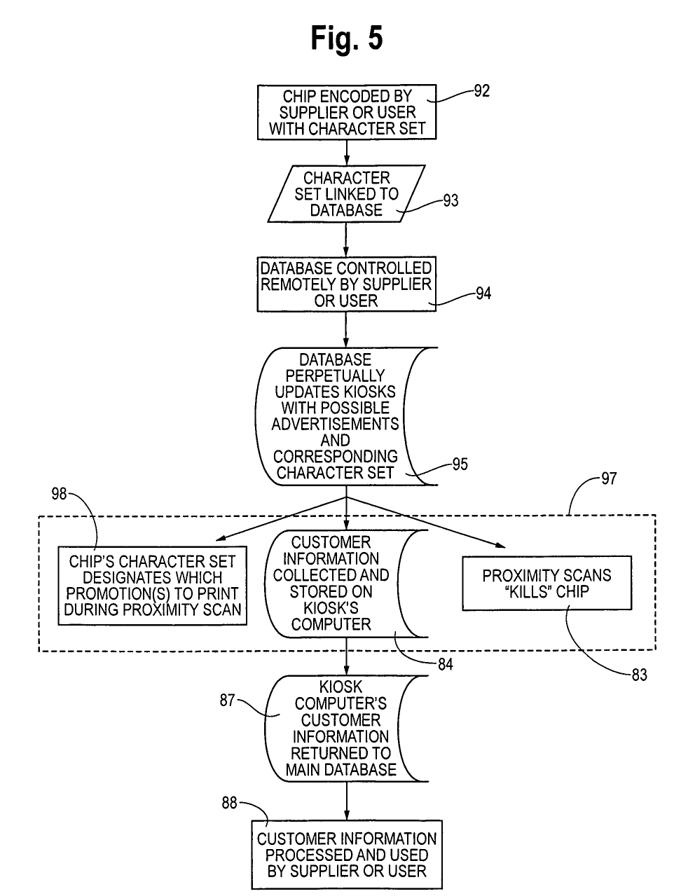

In comparison to the “smart chip” sequence of FIG. 4, the undertaken illustrated in FIG. 5 may receive the appellation as a “smart chip” plan. There, in the box 92, the RFID chip receives encoding by the tag supplier or the airline user, or both, with a character set, or information, relative to or indicative of the particular traveler and the information, promotions, or coupons that he or she should receive. This character set then links to the database at the box 93 which the tag supplier or airline user remotely controls as shown in the box 94.

This database, in the box 95, then updates the system's kiosks with a correlation between the character sets placed on the traveler's tag and the possible coupons, promotions, and other information that the individual will receive. In other words, all of the system's kiosks will receive the same correlation between the possible character sets on the RFID chip and the materials that the traveler with a particular character set should receive. The kiosk plays no role in determining which items of information, advertising, or coupons that the traveler will receive. Rather, the particular character set on the RFID chip will determine which of the kiosk's preloaded items the traveler should be provided with. This selection process is regularly updated at a central location for the system's kiosks taken together.

Based on the above, when the traveler presents his or her bag tag to the reader, the kiosk performs the tasks indicated in the dashed box 97. Most significantly, after the kiosk reads the tag's RFID chip, the character set on the chip tells the kiosk, at the box 98, which promotions and other items it should print for the particular traveler. Because the RFID chips control the selection process illustrated in FIG. 5, this process is entitled the “smart chip” undertaking. This distinguishes it from the “smart kiosk” set up of FIG. 4.

While the “smart kiosk” process of FIG. 4 and the “smart chip” system of FIG. 5 appear in the figures and the above description as entirely separate, they readily combine for even greater effectiveness. Thus, the smart chip system of FIG. 5 may determine to provide certain materials at the kiosk based on the individualized information contained on the chip for an individual traveler. At the same time, the kiosk may determine to provide additional materials based on the kiosk's particular location. Lastly, some commercial entities may have such wide appeal that they may wish to have their information or promotions provided at all system kiosks regardless of their locations and regardless of any particular characteristics of the individual travelers. A complex system would have the capability of combining and operating upon all of three concepts.

Returning briefly to FIG. 5, after providing the materials that the traveler should receive, the smart-chip system proceeds in the same manner as the smart kiosk process of FIG. 4 and accordingly, uses the same numbers for the same functions. Thus, the kiosk cancels the RFID chip in the box 83 to prevent its repetitive use. It also collects and stores information about the customer on its computer or other device at the box 84. This customer information travels to the system's database in the box 87 where it may be processed and used further at the box 88.

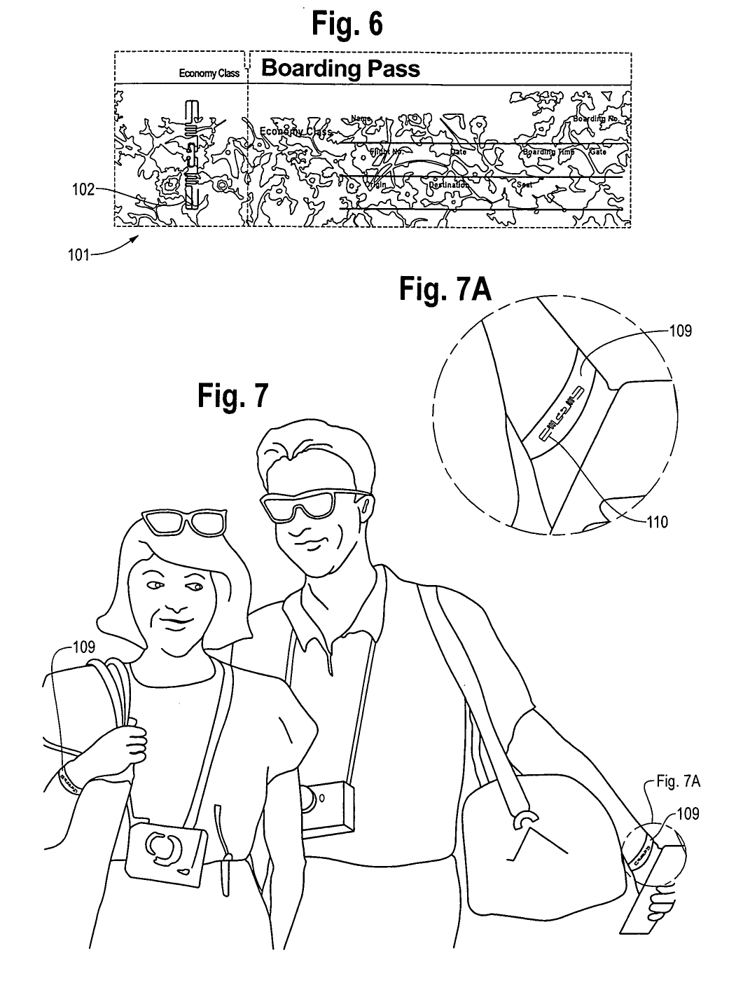

Naturally, situations may arise in which the traveler does not check luggage for the flight. For example, many “shuttle” flights take individuals between cities on relatively short trips that allow them to travel to their destination, conduct business, and return home the same day. Or, travelers may simply carry their baggage onto a plane without receiving any baggage tag whatsoever. However, the traveler, instead of a bag tag, can receive the boarding pass seen generally at 101 in FIG. 6. The pass 101 nay then include the embedded RFID chip 102. The chip 102 can perform all of the functions with all of the same results as the chip 21 of the prior figures. As an additional feature, the chip 102 in FIG. 6 may allow the facile determination of whether all of the passengers that have checked in for a flight have actually boarded the plane with its very significant ramifications for flight security purposes.

Other situations may exist, whether involving travel or not, where the individual may not have either baggage or a boarding pass. Yet, he or she may still be provided with some form of identification that can serve the same purposes as the bag tags and boarding passes discussed above. Such situations may exist in amusement parks, water parks, and even in hospitals. In such cases, the individuals may receive wrist bands such as the bands 109 in the FIGS. 7 and &A. These bands may incorporate the RFID chip 110 with all the benefits and uses of those of the prior figures.

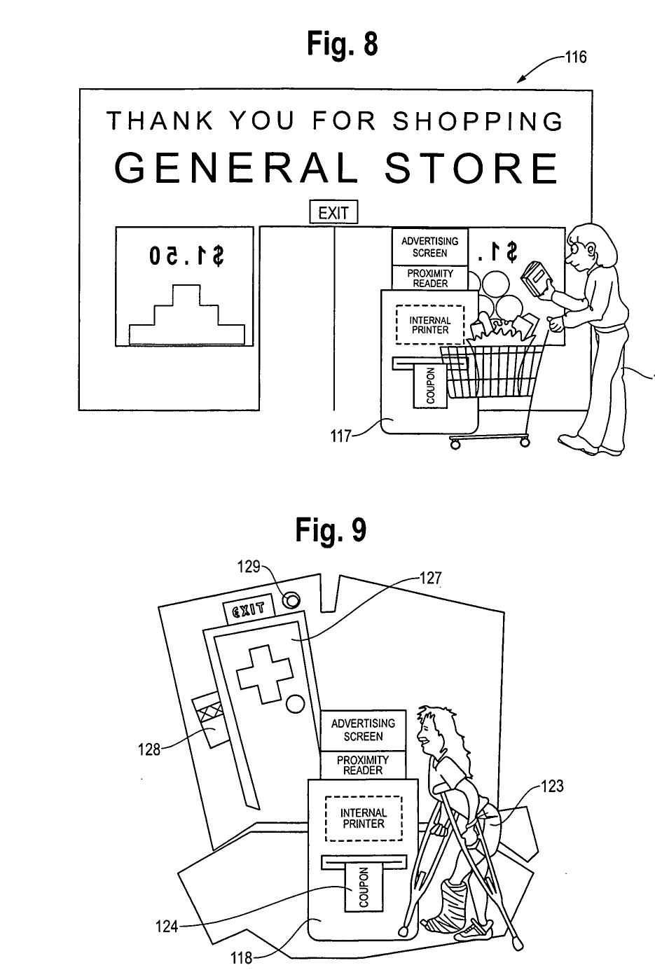

Further, similar concepts and uses of RFID chips may occur in other totally unrelated contexts. Thus, the shopper 115 at the store, indicated generally at 116, in FIG. 8 may also receive a sales receipt with an embedded RFID chip. Or, the frequent buyer card from the store may incorporate such a chip. Upon entering or exiting the store 116, the shopper may display the device with the RFID chip to the scanner 117 and receive suitable coupons, information, and other promotional items.

Especially beneficial uses may be obtained from the scanner seen in the hospital or clinic situation of FIG. 9. The patient 123 may carry a card or tag with an embedded RFID chip. Most frequently, however, the patient wears an identifying wrist band similar to the bands 110 of FIGS. 7 and 7A. In fact, most hospitals issue and attach such bands to all patients upon entering. These bands could well carry an embedded RFID chip.

Upon departing, the patient could present her or his wrist band with the chip to the kiosk 118. In turn, the kiosk could print out various coupons 124 that might have interest for that particular patient or for all patients. Even more importantly, the kiosk 118 could provide information of special significance to the patient such as recommended care and procedures that the patient should follow at home after leaving the hospital.

As before, the kiosk 118 can cancel the RFID chip carried by the patient 127 after it has provided her or him with the required information. This lets the scanner know not to provide a duplicate set of instructions.

Further, the exit door 127 of the hospital could carry the chip reader 128 in its vicinity. As patients depart the hospital, the reader could determine if any such individual was wearing a wrist band with an embedded chip that had not been canceled. This would indicate that the patient had not received the information intended for her or him. It might also suggest that the patient had not complied with some required check out procedure. When the reader determined that this situation existed, it could send out a visual alarm through the light 129 as well as an aural warning. It might also signal others that this particular patient needed some assistance to receive all of the information intended or her or him.

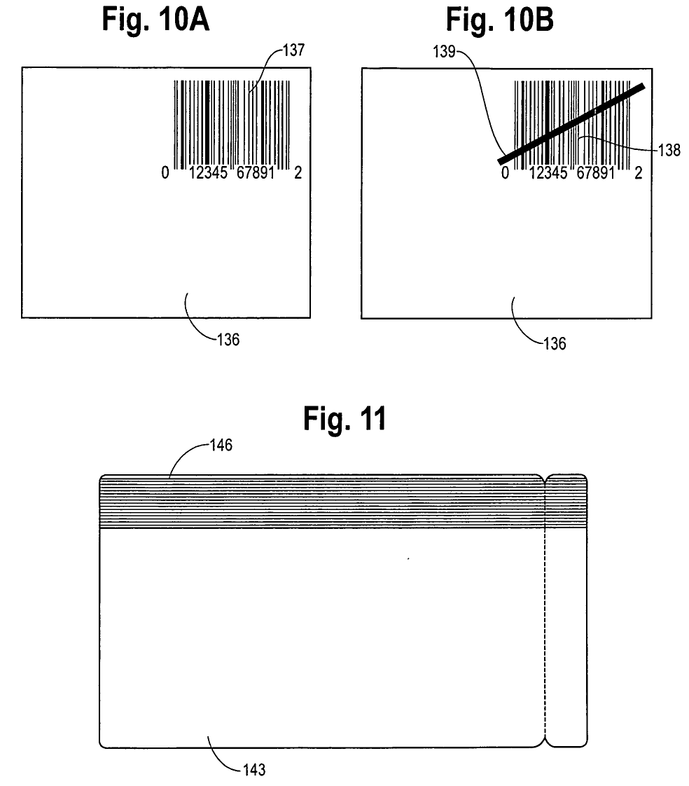

All of the foregoing discussion has centered upon the RFID chip as the information storage device. While the RFID chip has many advantages for this purpose, other information storing components may suffice for these purposes. Thus, for example, the card 136 in the FIG. 10A includes the optical code 137. As seen from UPC codes, the optical code 137 has the capability of storing substantial amounts of information. Upon use, the code 137 on the card 136 of FIG. 10A can undergo cancellation by drawing one or more lines though it, to leave the cancelled code 138 having the canceling line 139 printed across it as seen in FIG. 10B.

Lastly, the card 143 in the FIG. 11 carries the magnetic strip. 146. The strip can receive and carry information in a fashion very similar to an RFID chip. It also can undergo facile cancellation upon being read.

Accordingly, what is claimed is:

1. A method of providing a traveler or other consumer with offers, notices, and/or coupons particularly suited to said traveler or other consumer comprising:
A. providing said traveler or other consumer with a physical object containing information related to said traveler or other consumer;
B. providing a device capable of reading said information from said object at a location accessible to said traveler or other consumer;
C. reading said information with said device; and
D. after said device has read said information, providing to said consumer from said device said offers, notices, and/or coupons.

2. The method of claim 1 wherein said object comprises an RFID chip.

3. The method of claim 1 wherein said object comprises a label or tag with an embedded RFID chip.

4. The method of claim 3 wherein said label or tag is attached to luggage or other package.

5. The method of claim 4 wherein said tag is a luggage tag attached to a traveler's or other consumer's luggage or other package.

6. The method of claim 4 wherein said device reads said RFID chip and prints coupons specifically related to said traveler or other consumer.

7. The method of claim 4 wherein said device reads said RFID chip and prints coupons specifically related to the location where said device is located.

8. The method of claim 4 wherein said RFID chip includes the destination of the luggage or other package to which attached and said device reads said RFID chip and provides coupons characteristic of the destination contained on said luggage tag.

9. The method of claim 8 wherein said device provides coupons characteristic of the location of said device.

10. The method of claim 8 wherein said RFID chip includes information about said traveler or other consumer and said device reads, collects and stores said information about said traveler or other consumer.

11. The method of claim 4 wherein said RFID chip includes information about said traveler or other consumer and said device reads, collects and stores said information about said traveler or other consumer.

12. The method of claim 11 wherein said device, after reading the information on said RFID chip, writes to said RFID chip that the information on said RFID chip has been read.

13. The method of claim 12 wherein said device, when reading said RFID chip, will only provide coupons when said RFID chip has not been written to by a device indicating that said RFID chip had previously been read by a device.

14. The method of claim 4 wherein said device, after reading the information on said RFID chip, writes to said RFID chip that the information on said RFID chip has been read.

15. The method of claim 14 wherein said device, when reading said RFID chip, will only provide coupons when said RFID chip has not been written to by a device indicating that said RFID chip had previously been read by a device.

16. The method of claim 1 wherein said object comprises a ticket or other item carried by said traveler or other consumer with an embedded RFID chip.

17. The method of claim 16 wherein said device reads said RFID chip and prints coupons specifically related to said traveler or other consumer.

18. The method of claim 16 wherein said device reads said RFID chip and prints coupons specifically related to the location where said device is located.

19. The method of claim 16 wherein said RFID chip includes the destination of or said traveler other consumer and said device reads said RFID chip and provides coupons characteristic of said destination.

20. The method of claim 19 wherein said device provides coupons characteristic of the location of said device.

21. The method of claim 19 wherein said RFID chip includes information about said traveler or other consumer and said device reads, collects and stores said information about said traveler or other consumer.

22. The method of claim 16 wherein said RFID chip includes information about said traveler or other consumer and said device reads, collects and stores said information about said traveler or other consumer.

23. The method of claim 22 wherein said device, after reading the information on said RFID chip, writes to said RFID chip that the information on said RFID chip has been read.

24. The method of claim 23 wherein said device, when reading said RFID chip, will only provide coupons when said RFID chip has not been written to by a device indicating that said RFID chip had previously been read by a device.

25. The method of claim 16 wherein said device, after reading the information on said RFID chip, writes to said RFID chip that the information on said RFID chip has been read.

26. The method of claim 25 wherein said device, when reading said RFID chip, will only provide coupons when said RFID chip has not been written to by a device indicating that said RFID chip had previously been read by a device.

27. The method of claim 1 wherein said object comprises an item with an embedded RFID chip worn or carried by said traveler or other consumer.

28. The method of claim 27 wherein said device reads said RFID chip and prints coupons specifically related to said traveler or other consumer.

29. The method of claim 27 wherein said device reads said RFID chip and prints coupons specifically related to the location where said device is located.

30. The method of claim 27 wherein said RFID chip information distinctive of said traveler or other consumer and said device reads said RFID chip and provides coupons characteristic of said traveler or other consumer.

31. The method of claim 30 wherein said device provides coupons characteristic of the location of said device.

32. The method of claim 30 wherein said RFID chip includes information about said traveler or other consumer and said device reads, collects and stores said information about said traveler or other consumer.

33. The method of claim 27 wherein said RFID chip includes information about said traveler or other consumer and said device reads, collects and stores said information about said traveler or other consumer.

34. The method of claim 33 wherein said device, after reading the information on said RFID chip, writes to said RFID chip that the information on said RFID chip has been read.

35. The method of claim 34 wherein said device, when reading said RFID chip, will only provide coupons when said RFID chip has not been written to by a device indicating that said RFID chip had previously been read by a device.

36. The method of claim 27 wherein said device, after reading the information on said RFID chip, writes to said RFID chip that the information on said RFID chip has been read.

37. The method of claim 36 wherein said device, when reading said RFID chip, will only provide coupons when said RFID chip has not been written to by a device indicating that said RFID chip had previously been read by a device.

38. The method of claim 1 wherein said object is a luggage tag, a boarding pass, or a wrist band.

39. The method of claim 38 wherein said particular coupons, offers, and/or notices is contained on an object that said individuals can carry or wear.

40. The method of claim 39 wherein said object includes a magnetic area encoded with information.

41. The method of claim 39 wherein said object includes an optical display encoded with said information.

42. A method of advertising comprising:
A. entering into an agreement with an advertiser entity to provide coupons, offers, and/or notices to selected individuals;
B. deciding what categories of selected individuals will receive particular coupons, offers, and/or other information;
C. encoding a physical object with information particularly related to said selected individuals;
D. providing said selected individuals with said physical object;
E. providing a device capable of reading said information from said object at a location accessible to said selected individuals;
F. reading said information with said device; and
G. after said device has read said information, providing said particular coupons, offers, and/or notices to said categories of individuals from said device.

43. The method of claim 42 wherein said particular coupons, offers, and/or notices is contained on an object that said individuals can carry or wear.

44. The method of claim 43 wherein said object is a luggage tag, a boarding pass, or a wrist band.

45. The method of claim 44 wherein said object includes a magnetic area encoded with information.

46. The method of claim 44 wherein said object includes an optical display encoded with said information.

47. The method of claim 44 wherein said object comprises an RFID chip.

48. The method of claim 44 wherein said object comprises a label or tag with an embedded RFID chip.

49. The method of claim 48 wherein said label or tag is attached to luggage or other package.

50. The method of claim 4 wherein said tag is a luggage tag attached to a traveler's or other consumer's luggage or other package.

51. The method of claim 4 wherein said device reads said RFID chip and prints coupons specifically related to said traveler or other consumer.

52. The method of claim 4 wherein said device reads said RFID chip and prints coupons specifically related to the location where said device is located.

53. The method of claim 4 wherein said RFID chip includes the destination of the luggage or other package to which attached and said device reads said RFID chip and provides coupons characteristic of the destination contained on said luggage tag.

54. The method of claim 8 wherein said device provides coupons characteristic of the location of said device.

55. The method of claim 8 wherein said RFID chip includes information about said traveler or other consumer and said device reads, collects and stores said information about said traveler or other consumer.

56. The method of claim 4 wherein said RFID chip includes information about said traveler or other consumer and said device reads, collects and stores said information about said traveler or other consumer.

57. The method of claim 11 wherein said device, after reading the information on said RFID chip, writes to said RFID chip that the information on said RFID chip has been read.

58. The method of claim 12 wherein said device, when reading said RFID chip, will only provide coupons when said RFID chip has not been written to by a device indicating that said RFID chip had previously been read by a device.

59. The method of claim 4 wherein said device, after reading the information on said RFID chip, writes to said RFID chip that the information on said RFID chip has been read.

60. The method of claim 14 wherein said device, when reading said RFID chip, will only provide coupons when said RFID chip has not been written to by a device indicating that said RFID chip had previously been read by a device.

61. The method of claim 1 wherein said object comprises a ticket or other item carried by said traveler or other consumer with an embedded RFID chip.

62. The method of claim 16 wherein said device reads said RFID chip and prints coupons specifically related to said traveler or other consumer.

63. The method of claim 16 wherein said device reads said RFID chip and prints coupons specifically related to the location where said device is located.

64. The method of claim 16 wherein said RFID chip includes the destination of or said traveler other consumer and said device reads said RFID chip and provides coupons characteristic of said destination.

65. The method of claim 19 wherein said device provides coupons characteristic of the location of said device.

66. The method of claim 19 wherein said RFID chip includes information about said traveler or other consumer and said device reads, collects and stores said information about said traveler or other consumer.

67. The method of claim 16 wherein said RFID chip includes information about said traveler or other consumer and said device reads, collects and stores said information about said traveler or other consumer.

68. The method of claim 22 wherein said device, after reading the information on said RFID chip, writes to said RFID chip that the information on said RFID chip has been read.

69. The method of claim 23 wherein said device, when reading said RFID chip, will only provide coupons when said RFID chip has not been written to by a device indicating that said RFID chip had previously been read by a device.

70. The method of claim 16 wherein said device, after reading the information on said RFID chip, writes to said RFID chip that the information on said RFID chip has been read.

71. The method of claim 25 wherein said device, when reading said RFID chip, will only provide coupons when said RFID chip has not been written to by a device indicating that said RFID chip had previously been read by a device.

72. The method of claim 1 wherein said object comprises an item with an embedded RFID chip worn or carried by said traveler or other consumer.

73. The method of claim 27 wherein said device reads said RFID chip and prints coupons specifically related to said traveler or other consumer.

74. The method of claim 27 wherein said device reads said RFID chip and prints coupons specifically related to the location where said device is located.

75. The method of claim 27 wherein said RFID chip includes information distinctive of said traveler or other consumer and said device reads said RFID chip and provides coupons characteristic of said traveler or other consumer.

76. The method of claim 30 wherein said device provides coupons characteristic of the location of said device.

77. The method of claim 30 wherein said RFID chip includes information about said traveler or other consumer and said device reads, collects and stores said information about said traveler or other consumer.

78. The method of claim 27 wherein said RFID chip includes information about said traveler or other consumer and said device reads, collects and stores said information about said traveler or other consumer.

79. The method of claim 33 wherein said device, after reading the information on said RFID chip, writes to said RFID chip that the information on said RFID chip has been read.

80. The method of claim 34 wherein said device, when reading said RFID chip, will only provide coupons when said RFID chip has not been written to by a device indicating that said RFID chip had previously been read by a device.

81. The method of claim 27 wherein said device, after reading the information on said RFID chip, writes to said RFID chip that the information on said RFID chip has been read.

82. The method of claim 36 wherein said device, when reading said RFID chip, will only provide coupons when said RFID chip has not been written to by a device indicating that said RFID chip had previously been read by a device.

83. A method of providing offers, notices, and/or coupons to selected individuals comprising:
A. deciding what categories of selected individuals will receive particular coupons, offers, and/or notices;
B. encoding a physical object with information particularly related to said selected individuals;
C. providing said selected individuals with said physical object;
D. providing a device capable of reading said information from said object at a location accessible to said selected individuals;
E. reading said information with said device; and
F. after said device has read said information, providing said particular coupons, offers, and/or notices to said categories of individuals from said device.

84. The method of claim 83 wherein said coupons, offers, and/or notices is contained on an object that said individuals can carry or wear.

85. The method of claim 84 wherein said object is a luggage tag, a boarding pass, or a wrist band.

86. The method of claim 84 wherein said object includes a magnetic area encoded with said information.

87. The method of claim 86 wherein said device, after reading the information on said magnetic area, writes to said magnetic area that said information on said magnetic area has been read.

88. The method of claim 87 wherein said device, when reading said magnetic area, will only provide coupons, offers, and/or notices when said magnetic area has not been written to by a device indicating that said magnetic area had previously been read by a device.

89. The method of claim 87 further including reading with an alarm device said magnetic area when in proximity of said alarm device and, if said device has not written to said magnetic area that said that said information on said magnetic area has been read, providing a perceptible alarm.

90. The method of claim 84 wherein said object includes an optical display encoded with said information.

91. The method of claim 90 wherein said device, after reading said information on said optical display, writes to said optical display that the information on said optical display has been read.

92. The method of claim 91 wherein said device, when reading said optical display, will only provide coupons, offers, and/or notices when said optical display has not been written to by a device indicating that said optical display had previously been read by a device.

93. The method of claim 91 further including reading with an alarm device said optical display when in proximity of said alarm device and, if said device has not written to said optical display that said that the information on said optical display has been read, providing a perceptible alarm.

94. The method of claim 84 wherein said object comprises an RFID chip.

95. The method of claim 84 wherein said object comprises an item with an embedded RFID chip.

96. The method of claim 95 wherein said item is attached to luggage or other package or to an object worn by said selected individuals.

97. The method of claim 96 wherein said item is a luggage tag attached to a selected individual's luggage or other package.

98. The method of claim 96 wherein said device reads said RFID chip and prints coupons, offers, and/or notices specifically related to said selected individuals.

99. The method of claim 96 wherein said device reads said RFID chip and prints coupons, offers, and/or notices specifically related to the location where said device is located.

100. The method of claim 96 wherein said RFID chip includes the destination of the luggage or other package to which attached and said device reads said RFID chip and provides coupons, offers, and/or notices characteristic of the destination contained on said luggage tag.

101. The method of claim 100 wherein said device provides coupons, offers, and/or notices characteristic of the location of said device.

102. The method of claim 100 wherein said RFID chip includes information about said selected individuals and said device reads, collects and stores said information about said selected individuals.

103. The method of claim 96 wherein said RFID chip includes information about said selected individuals and said device reads, collects and stores said information about said selected individuals.

104. The method of claim 103 wherein said device, after reading the information on said RFID chip, writes to said RFID chip that the information on said RFID chip has been read.

105. The method of claim 104 wherein said device, when reading said RFID chip, will only provide coupons, offers, and/or notices when said RFID chip has not been written to by a device indicating that said RFID chip had previously been read by a device.

106. The method of claim 104 further including reading with an alarm device the information on said RFID chip when in proximity of said alarm device and, if said device has not written to said RFID chip that said that the information on said RFID chip has been read, providing a perceptible alarm.

107. The method of claim 96 wherein said device, after reading the information on said RFID chip, writes to said RFID chip that the information on said RFID chip has been read.

108. The method of claim 107 wherein said device, when reading said RFID chip, will only provide coupons, offers, and/or notices when said RFID chip has not been written to by a device indicating that said RFID chip had previously been read by a device.

109. The method of claim 107 further including reading with an alarm device the information on said RFID chip when in proximity of said alarm device and, if said device has not written to said RFID chip that said that the information on said RFID chip has been read, providing a perceptible alarm.

110. The method of claim 83 wherein said object comprises a ticket or other item carried by said selected individuals with an embedded RFID chip.

111. The method of claim 110 wherein said device reads said RFID chip and prints coupons, offers, and/or notices specifically related to said selected individual.

112. The method of claim 110 wherein said device reads said RFID chip and prints coupons, offers, and/or notices specifically related to the location where said device is located.

113. The method of claim 110 wherein said RFID chip includes the destination of or said selected individual and said device reads said RFID chip and provides coupons, offers, and/or notices characteristic of said destination.

114. The method of claim 113 wherein said device provides coupons, offers, and/or notices characteristic of the location of said device.

115. The method of claim 113 wherein said RFID chip includes information about said selected individual and said device reads, collects and stores said information about said traveler or other consumer.

116. The method of claim 110 wherein said RFID chip includes information about said selected individual and said device reads, collects and stores said information about said selected individual.

117. The method of claim 116 wherein said device, after reading the information on said RFID chip, writes to said RFID chip that the information on said RFID chip has been read.

118. The method of claim 117 wherein said device, when reading said RFID chip, will only provide coupons, offers, and/or notices when said RFID chip has not been written to by a device indicating that said RFID chip had previously been read by a device.

119. The method of claim 117 further including reading with an alarm device said optical display when in proximity of said alarm device and, if said device has not written to said optical display that said that the information on said optical display has been read, providing a perceptible alarm.

120. The method of claim 110 wherein said device, after reading said information on said RFID chip, writes to said RFID chip that the information on said RFID chip has been read.

121. The method of claim 120 wherein said device, when reading said RFID chip, will only provide coupons, offers, and/or notices when said RFID chip has not been written to by a device indicating that said RFID chip had previously been read by a device.

122. The method of claim 120 further including reading with an alarm device said RFID chip when in proximity of said alarm device and, if said device has not written to said RFID that said that the information on said RFID has been read, providing a perceptible alarm.

123. The method of claim 83 wherein said object comprises an item with an embedded RFID chip worn or carried by said selected individual.

124. The method of claim 123 wherein said device reads said RFID chip and prints coupons, offers, and/or notices specifically related to said selected individuals.

125. The method of claim 123 wherein said device reads said RFID chip and prints coupons, offers, and/or notices specifically related to the location where said device is located.

126. The method of claim 123 wherein said RFID chip information distinctive of said selected individual and said device reads said RFID chip and provides coupons, offers, and/or notices characteristic of said selected individual.

127. The method of claim 126 wherein said device provides coupons, offers, and/or notices characteristic of the location of said device.

128. The method of claim 127 wherein said RFID chip includes information about said selected individual and said device reads, collects and stores said information about said selected individual.

129. The method of claim 123 wherein said RFID chip includes information about said selected individual and said device reads, collects and stores said information about said selected individual.

130. The method of claim 129 wherein said device, after reading the information on said RFID chip, writes to said RFID chip that the information on said RFID chip has been read.

131. The method of claim 130 wherein said device, when reading said RFID chip, will only provide coupons, offers, and/or notices when said RFID chip has not been written to by a device indicating that said RFID chip had previously been read by a device.

132. The method of claim 130 further including reading with an alarm device said RFID chip when in proximity of said alarm device and, if said device has not written to said RFID that said that the information on said RFID has been read, providing a perceptible alarm.

133. The method of claim 123 wherein said device, after reading the information on said RFID chip, writes to said RFID chip that the information on said RFID chip has been read.

134. The method of claim 133 wherein said device, when reading said RFID chip, will only provide coupons, offers, and/or notices when said RFID chip has not been written to by a device indicating that said RFID chip had previously been read by a device.

135. The method of claim 133 further including reading with an alarm device said RFID chip when in proximity of said alarm device and, if said device has not written to said RFID that said that the information on said RFID has been read, providing a perceptible alarm.
